(19) United States
(12) Patent Application Publication
(10) Pub. No.: US 2002/0173888 A1
(43) Pub. Date: Nov. 21, 2002

(54) Aircraft location and tracking system

(76) Inventors: Robert Leo Shelton, Aurora, CO (US); Lewis Ruff Dodds, Denver, CO (US); Demetrius Ramone Ross, Denver, CO (US)

Correspondence Address: Robert L. Shelton, 15790 E. Monmouth PI., Aurora, CO, 80015, US

(21) Appl. No.: 10/037,880

(22) Filed: Jan. 7, 2002

Related U.S. Application Data
(60) Provisional application No. 60/292,310, filed on May 21, 2001.

(51) Int. Cl. G06F 7/00

(52) U.S. Cl. 701/35; 701/213; 701/215; 340/988

(57) ABSTRACT

An integrated flight safety apparatus containing a 12-channel GPS (Global Positioning System) receiver that networks a flight data recorder to a satellite communications system. This device is capable of providing real-time data acquisition and analysis to a ground-based monitoring and tracking station. The aircraft location and tracking system extracts data from any data collection device by utilizing serial port to serial port communications. A call is established from the tracking station to the apparatus, then the extracted data is polled to the base station at user defined intervals over the satellite link. Simultaneously, the aircraft's location is displayed on a moving aerial map in relation to its global position. In addition, different aerial maps, airspace mapping, waypoints, airports and runway approaches may be downloaded and displayed on the user's monitor and tracked on the remote monitor. This device utilizes voice command technology and can also be used as a satellite telephone device.

### BACKGROUND OF THE INVENTION

This invention relates to a GPS system designed for aircraft that includes the transfer of real-time flight data to a ground-based monitoring station. A GPS receiver determines the relative position and transmits it via communications satellite to a ground-based monitoring station. Bi-directional satellite communications can also be established from ground to air over the same unit enabling precise aircraft tracking that is more reliable than radar and radio signals. This apparatus can display and track an aircraft before it crashes. Most importantly, ground control, acting in the capacity of an added safety and security service, can monitor the aircraft's flight data and systems and act as an early warning system in the case of an emergency or even proactively prevent accidents. The overall purpose of this invention is to save lives by functioning as an early warning fault system. Safety in our aircraft is one of the most important transportation concerns today, especially since the tragic events of Sep. 11, 2001.

GPS devices are used to display location to users in the form of aeronautical, marine navigational and geographical mapping schemes. To be effective and serve its purpose, this GPS apparatus must be able to pinpoint location and transmit the data via satellite to a monitoring station. This is the first time the transfer of real-time flight data, combined with a GPS receiver and satellite transceiver has all coexisted in one integrated unit.

The original Global Positioning System is a series of 21 satellites and 3 spares for a total of 24 that circle the earth's orbit. Developed by the government, GPS has recently been released to the public using special public frequencies. Today, there are many more GPS satellites in orbit, but they operate using the same general principle. The satellites are positioned and carefully spaced so 4 are on any given horizon on the globe. From a ground-based GPS receiver, 3 satellites are needed to triangulate position. If the 4^{th} satellite is received, altitude and geographic position can be attained. There are 3 basic elements that are used to calculate position anywhere on the earth. First, time, which is calculated by a synchronized atomic clock located on the satellite. Second, Doppler phase shift and third, precise orbit information. Satellites have an error correction of about 4 minutes per 24-hours. Individual satellites send out a ranging signal on a 1.575 Ghz frequency. As the world turns and approximately every 12-hours, the satellites generally view the same areas over and over. With ground to orbit synchronization, slight corrections are implemented. This system is reliable within 100 meters. DGPS, a ground enhanced version that provides error correction for standard GPS, can be accurate up to 3 meters. Even more precise, special military-approved equipment can be accurate up to 1 meter.

GPS devices are becoming more popular everyday. From handheld devices to wristwatches to automobile tracking systems, these devices are becoming more integrated into our society. The agricultural world has already taken advantage of this technology when tracking livestock.

Collision avoidance GPS systems are a great tool to pilots. It is based on a volume-type signal combined with flight path information that is tracked by nearby planes to warn them when the danger of a collision is present.

Planes crash every year while many search and rescue teams simply can not find the wreckage. The emergency locator transmitter (ELT), which transmits a beacon-type FM signal, simply gives search crews a general range of where the aircraft might be. This proposed invention would not only give more general specific location, but the aircraft would not have to crash first before GPS tracking is engaged, as most current models of this version are activated on impact. Many planes, especially smaller aircraft, are not tracked by Air Traffic Control. They may experience a wide array of emergencies, such as the pilot is lost and low on fuel and can not be picked up by radar. If the pilot is flying too low and is under radar coverage or can not be tracked because of the conditions of the terrain, the Aircraft Tracking and Location System would use the more reliable method of GPS triangulation to determine its position. Therefore, the pilot could give Air Traffic Control its location, so they could assist in an emergency landing.

Agencies and departments, such as the NTSB (National Transportation Safety Board), DOT (Department of Transportation), FBI (Federal Bureau of Investigation) and other investigative authorities could analyze flight data remotely from a real-time analyzer previously saved and stored. Sometimes flight data recorders, known as the “Black Box”, are too damaged to analyze. This proposed invention would offer a viable solution to this problem. The audio output from the cockpit voice recorder could also be transmitted in real-time. Some advanced aircraft are experimenting with sight recorders, which can also be transmitted and saved. The aircraft location and tracking system is a highly advanced integrated safety apparatus.

### BRIEF SUMMARY OF THE INVENTION

An early warning safety device for monitoring aircraft systems and determining location when radar and radio are out of range or fail. A 12-channel GPS receiver via a global positioning calculation provides this more reliable form of determining location. This GPS location is displayed to the pilot and simultaneously transmitted via a communications satellite transceiver along with other flight control data to a ground-based monitoring station. The ground-based station is technically able to track the aircraft and proactively monitor flight data and flight instrumentation using the integrated satellite transceiver chip. This ground-based station may also communicate to the aircraft over the same integrated satellite transceiver providing a wide range of services and specialized assistance, including assistance in case of an emergency, security breach or any other 911 situation.

According to the scope of this invention, a flight data recorder, data collection station or any means of compiling and extracting data from the flight instrumentation panel is connected to the flight safety apparatus by a point-to-point serial port connection. By establishing this connection, the data can be forwarded over the satellite communications network.

According to the scope of this invention, this flight safety apparatus is an alternate communications network interface between the ground-based monitoring station and the flight data recorder. The aircraft location and tracking system also provides satellite communications for data, voice and video. As a secondary source, other critical calculations to a pilot may be confirmed, such as altitude and airspeed. Other helpful features include projected runway approaches and virtual geographical airspace mapping. Again, a communications satellite network is strictly used as the communications medium for this invention because it is more reliable than radio and radar.

This particular invention differs from most GPS devices because of its integration and communication with the flight data recorder. Today, this technology may exist independently, but by integrating these well-known devices, the Aircraft Tracking and Location System improves electronic performance and user capabilities. In the invention described above, a combination of multiple system interactions takes place over one unique interface.

### BRIEF DESCRIPTION OF THE SEVERAL VIEWS OF THE DRAWING

These drawings help to visually display the embodiment of the invention, showing multiple views, aspects, components and features accompanied by a brief itemized description.

FIG. 1 is a pictorial view of the circuit board and its components along with other system components that comprise the invention.

FIG. 2A is a block diagram of the aircraft location and tracking system components as they interconnect with each other and the system processor.

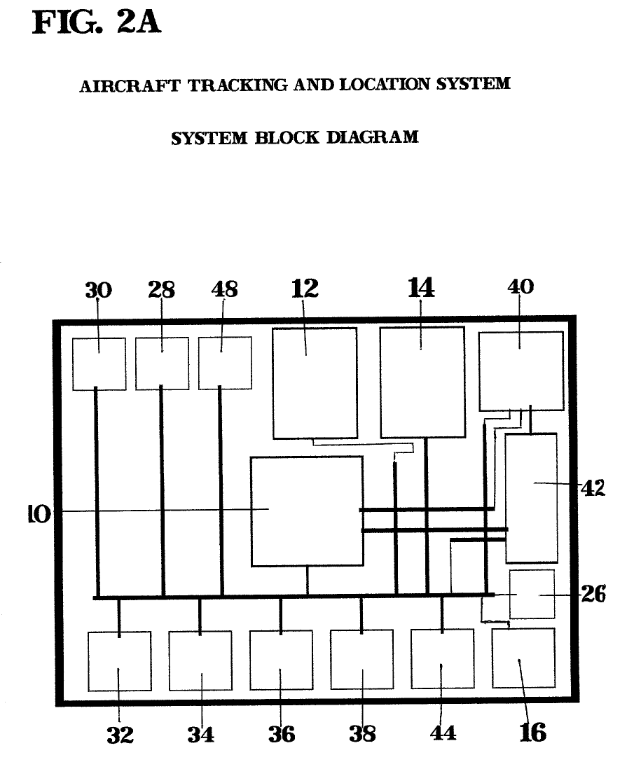

FIG. 2B is a block diagram of the front and rear view of the system components that comprise the invention.

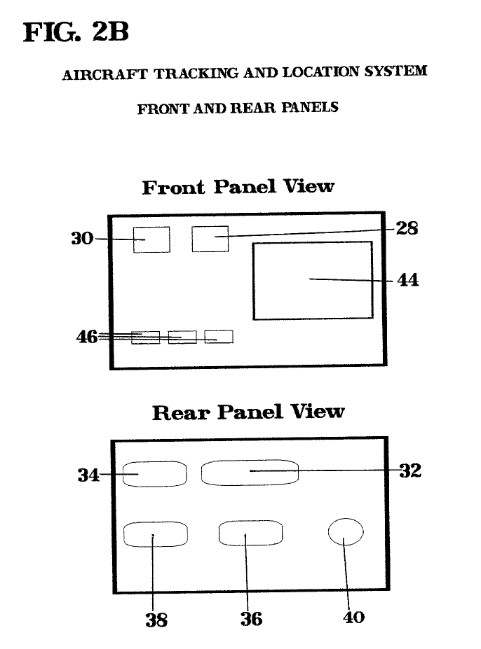

### NUMERICAL REFERENCED COMPONENT PART DESCRIPTION OF THE DRAWINGS

(10) Integrated System Processor.

A 64-bit RISC Chip CPU, capable of computing all process through the control, system and data busses built into the circuit board. Responsible for all data clocking rates and acts as the master controller of the apparatus.

(12) 12-Channel GPS Receiver with Built-In Antenna.

Tracks up to 12 GPS satellites simultaneously for speed and accuracy. Crucial to tracking GPS satellites in heavy cover. The built in antenna captures and relays the frequency of the GPS signal to the GPS receiver chip.

(14) Satellite Transceiver with Built-In Antenna.

Transmits and receives satellite communications signals over a satellite communications network. This satellite communications chip is able to transmit and receive voice and data communications over a high-speed connection. The built in antenna captures and relays the frequency of the satellite signal to the transceiver communications chip.

(16) ROM.

Read Only Memory. A pre-programmed set of commands, stored permanently on the microchips, that maintain the overall performance characteristics of the of the system such as start up system checks and diagnostics.

(26) Modem.

Standard AD/DA, digital to analog modem that modulates and de-modulates signals received and transmitted through the satellite communications link (14).

(28) Speaker.

This speaker is used to emit sound from audio prompts and for listening to voice communications.

(30) Microphone.

This is a microphone device for all audio input to be transmitted. Also, this microphone is used to input all voice driven commands and relaying vocal communications over the satellite communications link (14).

(32) Parallel/SCSI Interface Port.

SCSI is small computer serial interface. This parallel port is a multi-functional, bi-directional port that can be used to connect peripheral devices such as a SCSI hard drive or laptop computer.

(34) Other Serial Interface Port.

This is an optional specification/configuration multi-functional port that accepts input data from the output of other devices such as a PDA (Personal Digital Assistant, i.e., a Palm Pilot) or an aircraft GPS device.

(36) RS232 Serial Port.

This serial port is a multi-functional, bi-directional input/output (I/O) port that accepts standard RS232 pin out connections. RS232 is a universal connection specification that it used in our apparatus as an alternative connection type for devices that support its configuration, such as a laptop computer.

(38) RS232 Serial Port.

This is a dedicated serial port strictly used for the input of statistical and data collection devices such as a flight data recorder. This port is able to handle the input speed of real-time data information. This serial port is a multi-functional, bi-directional input/output (I/O) port that accepts standard RS232 pin out connections. RS232 is a universal connection specification that it used in our apparatus as an alternative connection type for devices that support its configuration, such as a laptop computer.

(40) Power Supply and Voltage Conditioning Unit.

This power distribution center receives its source power from the aircraft electrical system. The power supply unit distributes DC power to all system components. This unit also contains a voltage regulator and a fuse.

(42) Nicad Battery Backup Unit.

This battery is a memory enhanced trickle-charged backup cell with an 8-hour power life. The power supply (40) can seamlessly switch over to battery backup in case of an electrical outage or power failure on the aircraft.

(44) LCD Display Screen.

An LCD (Liquid Crystal Display) display screen located on the front panel of the apparatus that is used to monitor text and graphical images such as GPS moving maps.

(46) LED's.

LED's are light emitting diodes. These system lights are located on the front panel of the apparatus. They are diagnostic lights used to visually alert the user to the status of the system such as “Power On”. A solid green light is an indicator for “Normal”; A solid yellow light indicates that there may be a “Problem”; A solid red light indicates a serious “Problem” or system “Failure”. Lights may also enter a flashing state to indicate different meanings such as “Downloading”.

(48) System Battery.

The system battery is a small battery located on the circuit board that maintains the system time and date. The system battery may also be used in conjunction with the EEPROM programmable smart chip (10) to store personalized settings and passwords.

### DETAILED DESCRIPTION OF THE INVENTION

As described above, many drivers and pilots who operate transportation vehicles are using GPS technology to further enhance their performance. Navigational data is key to users who want to make adequate and informed decisions relating to geographical maps and services on the way to their destination. The aircraft location and tracking system proposed by this invention integrates a flight data recorder and GPS receiver for determining location and a communications satellite transceiver, which a call is established and constantly polled at user defined intervals to track the aircraft and monitor real-time flight data.

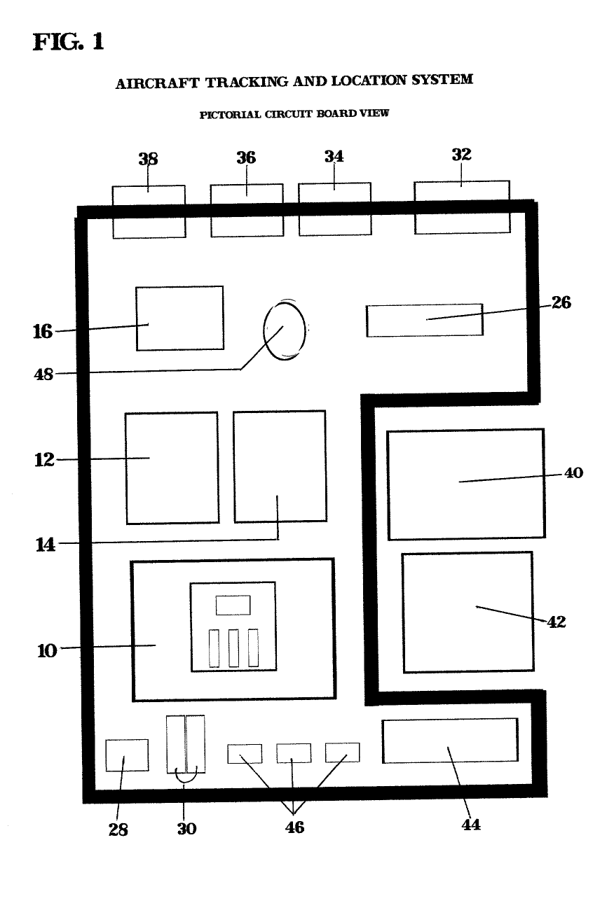

FIG. 1 is a relative view and embodiment of a circuit board design of the invention containing four separate serial interfaces accommodating multiple protocols and connection types.

FIG. 1 is a schematic representation showing the integrated system processor 10 coupled to the GPS receiver 12 and the satellite transmitter/receiver 14 via the circuit board data and control bus circuitry. An integrated system processor 10 which is a 32-bit RISC chip central processing unit, is capable of computing all processes and commands through the control, system and data busses built into the circuit board. The CPU 10 is responsible for all data clocking rates via its integrated oscillator and acts as the master controller of the apparatus.

The GPS receiver chip with built-in antenna 12 contains 12-channels that can be all used simultaneously to triangulate orbiting GPS satellites for greater accuracy. The built-in antenna captures and relays the frequency of the GPS signal to the GPS receiver chip 12. Pertaining to the satellite transceiver chip with built-in antenna 14, this chip can transmit and receive satellite signals over a satellite communications network. This satellite communications chip 14 is able to transmit and receive voice, video and data communications over a high-speed connection. The built-in antenna captures and relays the frequency of the satellite signal to the transceiver communications chip 14. The serial port connector 38, which is mounted near the end of the circuit board, is used to connect the flight data recorder to the flight safety apparatus, as shown in FIG. 1. The drawing shows explicitly one of the serial ports is an RS-232 serial port connector that is a standard connection type found on general computer equipment.

Pertaining to the drawings of FIG. 1, there are four serial ports attached to the circuit board 32, 34, 36, and 38. Two of the four types shown are meet RS-232 and Parallel/SCSI standards and specifications.

Pertaining to the drawings of FIG. 1, the integrated processor 10 contains a smart chip known as an (EEPROM) electronically erasable programmable read-only memory, to allow enhanced functionality that can be utilized for uploading, downloading, storing and deleting saved information. Pertinent information may include downloading aerial maps, waypoints and other user identification features. The smart chip can be used to perform system upgrades and to store user data. The integrated RAM (Random Access Memory) on the processor 10 is also used for storing program variables and assists in buffering data.

The (ROM) read-only memory chip 16 stores pre-programmed system and operational data and is linked to the (RAM) random-access memory, located in the integrated processor, 10 which stores information dynamically as needed. RAM memory 10 is used to run loadable programs. The RAM 10 is also used for storing program variables and assists in buffering of data. An electronically erasable programmable read-only memory (EEPROM) smart chip 10, located inside the integrated processor, is capable when in bootstrap mode of downloading programs. Again, downloading from this EEPROM or alternative nonvolatile memory device, e.g., FLASH memory is the primary function of the EEPROM.

The modem 26 converts analog signals to digital signals that may be interpreted by the system processor 10 and vice-versa over the communications link 14. The modem 26 converts data that has been formatted by the CPU 10 into data bus-compatible signals. Conversely, the modem 26 also converts data bus compatible signals into data, which the CPU 10 processes for transmission to the satellite transceiver chip 14. The modem 26 is linked to the CPU 10 over a bi-directional parallel data bus.

The influx of real-time information can increase to extremely high levels, which can be buffered through the integrated system processor 10. The buffers 10 help to control high levels of data the processor 10 can compute at any given time from the data input interface port 34, the RS232 serial port 36, the parallel/SCSI interface port 32, and the serial port 38.

This device has system programming that understands and carries out voice activated commands which are recognized through the system microphone 30. In addition, the device can generate audio responses through the system speaker 28. Visual graphical displays such as GPS moving maps are generated through the LCD display screen 44 located on the front panel offering a full spectrum communications device. Other visual aides include system LED's 46 located on the front panel. These colored lights provide visual alerts and diagnostics of the systems performance.

The main power supply and voltage-conditioning unit 40 receives its electrical source form the aircraft's power distribution system. The power supply unit 40 distributes and regulates DC power to all system components and contains a fuse. In the case of an aircraft power outage, a Nicad battery backup unit 42 will resume system power, which is trickle charged by the power supply 40. This is an 8-hour backup cell, which seamlessly switches over when a power failure is detected. The circuit board has a self-contained system battery 48 that maintains the time and date. The system battery is linked to the programmable smart chip 10 to store personalized settings and passwords.

The power supply 40 provides a stabilized voltage and DC power output for powering the other components of the interface circuit. The power supply 40 can transfer power through any serial port such as 38, to which the flight data recorder is linked. The power requirement of the interface device is low enough so that any personal computer, including a laptop or notebook computer, can provide the necessary power from the serial port.

The power supply 40 also generates a reset signal for resetting the CPU 10. The reset signals pulled low when the power is removed from the interface device and is held low for predetermined amount of time after the reapplication of power, thereby ensuring that the CPU begins to operate from a known initial state. The predetermined amount of time that the reset signal is held low is equal to or greater than the time required for the power supplied to stabilize.

The power supply 40 is implemented using conventional, commercially available power supply components.

In further detail, the unspecified serial port (34) is reserved for airline specific specifications or any future port specifications that may be used for the purpose of transmitting and receiving data to and from the aircraft location and tracking system interface. The optional port is not limited to RS232 or SCSI port specifications and may be used for any port specification that is compatible.

The claims are:

1. An integrated flight apparatus for networking a flight data recorder or data collection system to a multifunctional GPS receiver and satellite communication tracking device comprising:
An integrated microprocessor incorporating on board RAM (Random Access Memory), buffers and EEPROM (Electrically erasable programmable read-only memory). The processor or CPU (Central Processing Unit) is attached to the circuit board via the data and system busses. These circuits connect every component on the circuit board providing bi-directional communication between component devices. The CPU is responsible for processing data from the satellite transceiver, GPS receiver, LCD (Liquid Crystal Display) screen and any other data that can be inputted and outputted through the serial ports;
Multiple serial ports (Four) with alternate protocol specifications such as RS-232 and Parallel/SCSI (Small Computer Serial Interface). The serial ports that are attached to the processor via the circuit board for data and signal exchange;
ROM (Read-only memory) microchips are linked to the processor via the system and data bus that provides operational system pre-programmed functions and calculations;

2. The integrated GPS device recited in claim 1, containing an embedded modem (Modulator/demodulator), that is used to convert analog signals to digital signals, and vice-versa, digital signals to analog signals, by the process of modulation and demodulation. All computer-based electronics and equipment communicate digitally on the same circuit board or remotely with each other, but is generally transmitted over an analog frequency connecting the devices. The modem accommodates the two distinct frequencies and translates between them. Quite often, telephone companies and (ISP's) Internet Service Providers transmit data over an analog signal.

3. The integrated GPS device recited in claim 1, comprising a rugged external covering completely encased around the apparatus, suitably built to meet the requirements of mounted aircraft equipment approved by the (FAA) Federal Aviation Administration.

4. The integrated GPS device recited in claim 1, claiming no electronics embodied in the flight apparatus interfere with the normal operation of an aircraft or any other electronic device on an aircraft, according to FAA equipment requirements.

5. The integrated GPS device recited in claim 3, where at least one of the serial ports attached to the flight apparatus meet RS-232 connection specification standards.

6. The integrated GPS device recited in claim 1, where the flight apparatus draws its primary power from the aircraft's existing electrical system.

7. The integrated GPS device recited in claim 1, where the flight apparatus includes a serial port connection that can be directly interfaced with a serial port on a flight data recorder for transporting data.

8. The integrated GPS device recited in claim 1, where the integrated processor includes an EEPROM smart chip.

9. The integrated GPS device recited in claim 8, comprising a software driver that oversees the control parameters of hardware's functionality between the data ports of the flight apparatus and the flight data recorder.

10. The integrated GPS device recited in claim 9, comprising an integrated oscillator that is responsible for generating all system clocking parameters (Timing) for the processor, modem and all other circuit board components.

11. The integrated GPS device recited in claim 8, where the processor is unified in one integrated microchip.

12. The integrated GPS device recited in claim 11, where the processor computes and executes software during normal operation and is capable of software storage, even in the absence of power.

13. The integrated GPS device recited in claim 8, comprising four serial connectors attached to the flight apparatus to interface the flight data recorder and other alternative flight system data collectors.

14. The integrated GPS device recited in claim 1, where the integrated processor includes nonvolatile flash memory for saving and storing downloaded programs that are executed by the processor.

15. The integrated GPS device recited in claim 1, comprising a built in condenser microphone (MIC) on the flight apparatus for capturing and relaying all audio input. The mic is able to send voice transmissions and understand voice commands.

16. The integrated GPS device recited in claim 1, comprising a built-in speaker system on the flight apparatus that is responsible for delivering sound to the user.

17. An interface device for interfacing a flight data recorder with a GPS receiver and tracking device, a satellite transceiver and providing real-time data analysis to a display screen and ground-based monitoring station, comprising:
A processor linked to the serial port for processing data from the flight data recorder and the GPS receiver for bi-directional communications with the satellite transceiver, including;
A power supply conditioning unit linked to the system components and for providing predetermined electrical characteristics for signals transmitted to and received from the interface device. Also, supplying a means for stabilizing DC voltage to the flight apparatus system components,
An integrated GPS 12-channel receiver capable of triangulating global position on an aerial moving map and forwarding that information via modem and satellite transceiver to a ground-based tracking and monitoring station,
An integrated satellite transceiver capable of providing satellite communications over a high-speed satellite network. Polling of data is initialized from the ground-based monitoring station at user defined intervals. This transceiver can bi-directionally carry voice, data and video.
